(19) United States
(12) Patent Application Publication
(10) Pub. No.: US 2004/0208638 A1
(43) Pub. Date: Oct. 21, 2004

(54) Communication system using entangled photons

(76) Inventor: David B. Jansen, Louisville, CO (US)

Correspondence Address: PATTON BOGGS, 1660 LINCOLN ST, SUITE 2050, DENVER, CO, 80264, US

(21) Appl. No.: 10/140,576

(22) Filed: May 7, 2002

(51) Int. Cl. H04B 10/00; H04B 10/04

(52) U.S. Cl. 398/183

(57) ABSTRACT

A system and method for optical communication employing entangled photons. A modulator selectively extends the optical path length of one conjugate photon of each entangled photon pair, thereby incorporating a bit value in the entangled photon pair. The entangled photon pair is transmitted and passed through a spectrometer, which separates the photons according to their frequency and directs them to a coincidence counter. A decline in a curve of a number of coincidence counts plotted against conjugate photon frequency disparity is employed to extract the bit value.

### BACKGROUND OF THE INVENTION

1. Field of the Invention

The present invention relates in general to optical communication and in particular to communicating by manipulating photon characteristics.

2. Statement of the Problem

Although numerous advances have been enjoyed in the optical communications field, the data capacity of a fiber optical cable is finite, and current technology is approaching the theoretical performance limits of conventional optical fibers. Attenuation, dispersion, and other non-linearities generally limit the information bandwidth of the fiber. Dispersion is the spreading of a light pulse as it travels down the length of an optical fiber. Different wavelengths or colors forming an optical transmission travel at different velocities through fiber optic cables. Variation in velocity of the various component wavelengths of such optical transmissions tends to broaden the temporal pulse width of the transmissions, thus limiting the rate at which such pulses can be transmitted through the fiber. Accordingly, as progressively higher transmission bandwidths are used with fiber optic systems, dispersion is generally the limiting factor operating to limit the rate of data transmission through such systems. Low dispersion fiber optical cable is now being developed and deployed. However, even the more advanced fiber optic systems currently under development likely will not be capable of handling the high transmission bandwidths envisioned in future systems. Furthermore, millions of kilometers of fiber optic cable are already installed and deployed throughout the world, and it would be cost-prohibitive to replace this installed base of cable. Therefore, it is highly desirable that future approaches to fiber optic technology be capable of using the installed and deployed base of fiber optic cable.

Quantum theory has been a powerful mechanism for explaining phenomena in a variety of industrial applications. An understanding of quantum theory has enabled the design of many devices currently in use, including computers, cell phones, and DVD (Digital Versatile Disk) players. In recent years, there has been research into the phenomenon of quantum entanglement. Quantum entanglement describes correlations between the results of local measurements performed on two or more particles. However, these correlations are non-local and cannot be accounted for by ordinary probabilistic reasoning. It has been shown that dispersion effects can be canceled in entangled quantum systems. See J. D. Franson, “Nonlocal cancellation of dispersion”, Physical Review A, Vol. 45, No. 5, 1 Mar. 1992, pp. 3126-3132 and A. M. Steinberg et al., “Dispersion Cancellation in a Measurement of the Single-Photon Propagation Velocity in Glass”, Physical Review Letters, Vol. 68, No. 16, 20 Apr. 1992, pp. 2421-2424. Researchers are currently developing applications that employ quantum entanglement. These applications include quantum cryptography; dense coding; quantum teleportation, which transports quantum properties to distant locations; quantum computers which are, in theory, capable of solving problems in seconds that today are unsolvable; and quantum lithography, which would allow semiconductor devices to be made much smaller than current technology allows. See Paul G. Kwiat et al., “Ultra-bright source of polarization-entangled photons”, PRA, arXivLQuant-ph/9810003v32, 22 May 1999, pp. 1-4, Paul G. Kwiat et al., Physics Review A (6) 1999, pp. 773-776, and U.S. Pat. No. 6,252,665 B1 issued Jun. 26, 2001 to Williams et al. Generally, quantum communications involves transmitting quantum states to distant locations. Proposed applications include the development of absolutely secure communication channels, such as using quantum key distribution; and dense coding, which allows more than one bit of classical information to be sent on a single quantum bit. See, for example, U.S. Pat. No. 6,314,189 B1 issued Nov. 6, 2001 to Motoyoshi et al.

Accordingly, there is a need in the art for a communication system which is able to employ existing fiber optic cable for high bandwidth communication which is substantially free of dispersion and non-linear effects.

### SOLUTION

The present invention solves the above problems by providing a method and apparatus for classical communication using entangled photons. Systems and methods of communication are provided preferably incorporating bit values into the characteristics of quantum entangled photons transmitted over a communication link to a receiver able to extract the incorporated bit values from the received entangled photons.

A preferred approach to incorporating bit values into transmissions of entangled photons involves selectively adjusting an optical path length of a trajectory of at least one entangled photon of a group of entangled photons. Generally, where no delay is established for any of the photons, an ensemble of entangled photon pairs experience a coincidence pattern associated with a logic zero value at a receiver. Where the optical path of a selected entangled photon is deliberately modified, detection circuitry preferably detects a coincidence pattern associated with a logical one bit value.

In this manner, a preferred embodiment of the present invention is able to rapidly transmit bit values over a fiber optic link, or other communication link, employing quantum entangled photons, thereby insulating such transmission against the limiting factors of dispersion and non-linearities which typically operate as limiting factors on the performance of existing fiber optic communication systems.

Advantageously, the present invention provides a high speed data communication system employing entangled photons. Preferably, this communication system benefits from dispersion cancellation, which cancellation generally occurs regardless of the type or length of the fiber, or other type of communication link, employed. The inventive system preferably employs an ensemble of entangled photon pairs (or higher levels of entanglement). The inventive system preferably has a high dynamic range allowing communication to be successfully conducted even in the presence of perturbations in the fiber optic link.

The inventive system preferably further includes a novel spectrometer, detector and coincidence detection system. In a preferred embodiment of the present invention, a simple form of modulation may be employed which may beneficially be accomplished employing a simplified Mach-Zender modulator.

The invention provides a communication method comprising: incorporating information into a pair of entangled photons; transmitting said entangled photons; receiving said entangled photons; and extracting said information from said received pair of entangled photons. Preferably, the act of incorporating comprises modulating an optical path of one of said pair of entangled photons. Preferably, the act of modulating comprises selectively controlling an index of refraction for a portion of a trajectory of said one photon. Preferably, the act of selectively controlling said index of refraction comprises adjusting the electromagnetic field in said portion of a trajectory. Preferably, the act of modulating comprises selectively controlling a physical length of a trajectory of said one photon. Preferably, the act of transmitting comprises transmitting over a fiber optic link. Preferably, the act of receiving comprises directing one of said entangled photons along a first path and directing the other of said entangled photons along a second path. Preferably, the act of receiving further comprises delaying said one of said entangled photons along said first path. Preferably, there is a plurality of said entangled photon pairs and said extracting comprises spatially separating photons according to their frequency. Preferably, the act of extracting further comprises impinging said spatially separated photons onto a photodetector array. Preferably, the act of receiving comprises directing a first set of said entangled photons along a first path and directing a second set of said entangled photons along a second path; the act of spatially separating comprises spatially separating said first set at a first location and spatially separating said second set at a second location; the act of impinging comprises impinging said first set onto a first detector array and impinging said second set onto a second detector array; and the act of extracting further comprises determining a pattern of coincidence of impingement of photons of said first set onto said first array with the impingement of photons of said second set onto said second array and producing a decoded signal characteristic of said coincidence.

Preferably, the act of incorporating comprises incorporating a digital logic state onto said entangled photons, and said extracting further comprises detecting said digital logic state in said decoded signal. Preferably, the act of extracting comprises determining a coincidence pattern of said received entangled photons. Preferably, the act of determining a coincidence pattern comprises identifying a detector element within an array of detector elements at which a coincidence decline occurs. Preferably, the act of determining a coincidence pattern comprises determining that a coincidence decline does not occur at a predetermined detector element within an array of detector elements.

In another aspect, the invention provides a method for communicating a digital logical state, the method comprising: providing a digital logic state; providing a pair of entangled photons; establishing the optical path of one of said entangled photons in accordance with said digital logic state; transmitting said entangled photons to a receiver; and extracting said digital logic state from said received entangled photons. Preferably, the act of extracting comprises determining a coincidence pattern of said received entangled photons at said receiver. Preferably, the act of determining a coincidence pattern comprises identifying a detector element within an array of detector elements at which a coincidence decline occurs. Preferably, the act of determining a coincidence pattern comprises determining that a coincidence decline does not occur at a predetermined detector element within an array of detector elements. Preferably, the act of establishing the optical path comprises delaying said one of said entangled photons.

According to yet another aspect, the invention provides a communication system comprising: an entangled photon transmitter comprising: a source of entangled photons; a source of information; and a modulator responsive to said source of information for incorporating said information into said entangled photons; an entangled photon receiver including an entangled photon decoder providing an output signal characteristic of said information; and a communication link for carrying said entangled photons from said transmitter to said receiver. Preferably, the source of entangled photons comprises: a source of initial photons; and a spontaneous parametric down converter for producing a group of entangled photons from each of said initial photons. Preferably, the modulator comprises an electro-optical transducer. Preferably, the electro-optical transducer comprises a material in which the index of refraction is dependent on voltage. Preferably, the decoder comprises a spectrometer and a coincidence circuit array. Preferably, the spectrometer comprises a diffraction grating and a photodetector array. Preferably, the decoder comprises a first path including a first said diffraction grating and a first said photodetector array, and a second path comprising a second said diffraction grating and a second said photodetector array. Preferably, the decoder further includes a logic state detector. Preferably, the logic state detector comprises a computer. Preferably, the communication link comprises an optical fiber. Preferably, the transmitter comprises an optical path adjuster. Preferably, the source of entangled photons comprises a pump laser. Preferably, the source of entangled photons comprises a polarizer. Preferably, the receiver includes two photon paths and an optical path adjuster along one of said optical paths. Preferably, the information comprises a sequence of bit values.

According to yet another aspect, the invention provides a data storage method comprising: generating a plurality of entangled photon pairs; incorporating one bit value into said generated plurality of photon pairs; extracting said incorporated bit value upon concluding an entanglement condition of said entangled photon pairs; and storing said extracted bit value. Preferably, the act of incorporating comprises adjusting an optical path of one photon of each said entangled photon pair.

According to yet another aspect, the invention provides a communication system comprising: an existing communication link; an entangled photon transmitter, adapted to cooperate with said existing communication link, comprising: a source of entangled photons; a source of information; and a modulator responsive to said source of information for incorporating said information into said entangled photons; an entangled photon receiver, adapted to cooperate with said existing communication link, including an entangled photon decoder providing an output signal characteristic of said information, wherein said existing communication link is operative to carry said entangled photons from said transmitter to said receiver.

According to yet another aspect, the invention provides a method for providing communication employing existing communication equipment, the method comprising: selecting an existing communication link; coupling an entangled photon transmitter to said selected existing communication link; coupling an entangled photon receiver to said selected existing communication link; and transmitting information from said coupled entangled photon transmitter to said coupled entangled photon receiver.

The invention provides an optical communication system that is relatively insensitive to dispersion that can be used with conventional fiber optic systems. Numerous other features, objects, and advantages of the invention will become apparent from the following description when read in conjunction with the accompanying drawings.

### BRIEF DESCRIPTION OF THE DRAWINGS

FIG. 1 is a block diagram of a transmitter of entangled photons according to a preferred embodiment of the present invention;

FIG. 2 is a block diagram of a receiver for receiving entangled photons according to a preferred embodiment of the present invention;

FIG. 3 is a block diagram of a portion of a communication system employing the transmission of entangled photons according to a preferred embodiment of the present invention;

FIG. 4 is a flow diagram of the operation of the inventive system according to a preferred embodiment of the present invention;

FIG. 5A presents a plot of coincidence counts against a coincidence detector element number when the transmitter modulator is turned off according to a preferred embodiment of the present invention;

FIG. 5B presents a plot of coincidence counts against a coincidence detector element number when the transmitter modulator is turned on according to a preferred embodiment of the present invention;

FIG. 6 is a flow diagram of output data generation at a receiver according to a preferred embodiment of the present invention; and

FIG. 7 is a flow diagram of bit value determination from coincidence count profiles according to a preferred embodiment of the present invention.

### DETAILED DESCRIPTION OF THE PREFERRED EMBODIMENT

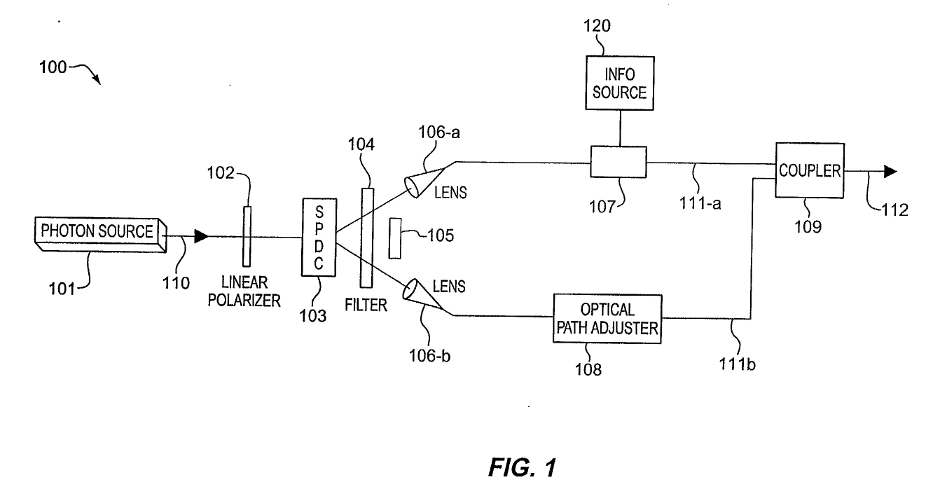

Herein, the term “initial photon” generally corresponds to a photon which emerges from photon source 101 (FIG. 1) and which has not been broken down into an entangled photon pair; the term “entanglement group” generally corresponds to a group of entangled photons created by down-converting a single initial photon into a plurality of entangled photons. Herein, the terms “group of entangled photons” and “entangled photon group” are equivalent to the term “entanglement group”, and the term “entangled photon pair” generally corresponds to a special case of an entanglement group having exactly two entangled photons.

Herein, the term “optical” generally refers to all frequencies within the electromagnetic spectrum. Herein, the term “coincidence decline” generally corresponds to a relative decrease in an amount of coincidence (a number of coincidence counts) at one or more coincidence circuits in comparison with an amount of coincidence at other coincidence circuits within a coincidence circuit array. Herein, the term “coincidence null” generally corresponds to a complete absence of coincidence at one or more coincidence circuits within a coincidence circuit array. Herein, the scope of the term “coincidence decline” generally includes a “coincidence null” but is not limited thereto.

Herein, the term “optical path” generally corresponds to the integral, over elements of length along a path traveled by a photon, of the refractive index. Herein, the terms “effective optical path length”, “optical path length”, and “optical distance” are equivalent to the term “optical path” described above. Herein, the term “physical length” generally corresponds to a measure of geometric distance which is independent of the optical characteristics of the space or material over such distance.

Herein, the term “conjugate photons” generally corresponds to two photons forming an entangled photon pair. Accordingly, each photon's “conjugate photon” is the other photon in this pair. The term “conjugate frequencies” generally corresponds to the frequencies of photons within an entangled photon pair. Accordingly, the “conjugate frequency” of an entangled photon frequency is the frequency of the other photon of this entangled photon pair.

Herein, the term “conjugate detector elements” generally corresponds to a pair of detector elements which receive conjugate photons of an entangled photon pair wherein the frequencies of these photons sum to the frequency of the initial photon from which this entangled photon pair was generated; and the term “conjugate detector” is generally equivalent to the term “conjugate detector element”. Herein, the terms “coincidence circuit” and “coincidence detector element” generally correspond to a circuit which provides a defined electrical output in response to a receipt of conjugate photons of an entangled photon pair.

Herein, the term “coincidence gate time” generally corresponds to the maximum disparity in arrival time of conjugate photons of an entangled photon pair at a coincidence detector element for a coincidence count to be generated. Herein, the term “conjugate photon trajectories” generally corresponds to trajectories along which entangled photons travel without their respective conjugate photons.

Herein, the term “classical” has the meaning of the term as used in physics; that is, to indicate a system that responds to an aggregate phenomenon, as distinguished from a quantum mechanical phenomenon that can only be measured when a quantum state collapses.

FIG. 1 is a block diagram of a transmitter 100 of entangled photons according to a preferred embodiment of the present invention. In a preferred embodiment, a photon source 101, which is preferably a laser (which laser may be a laser diode), generates initial photons, at a single established frequency, along photon propagation path 110. Linear polarizer 102 preferably operates to ensure that all photons emerging from pump laser 101 are in the same polarization plane. The operation of linear polarizer 102 is known in the art and, therefore, will not be discussed in detail herein.

After passing through linear polarizer 102, the photons from pump laser 101 preferably proceed to Spontaneous Parametric Down Conversion (SPDC) source 103. SPDC source 103 preferably operates to cause each one of a selection of initial photons to break down into an entangled photon pair. Alternatively, an initial photon could be down-converted into more than two entangled photons. Entanglement involving more than two entangled photons is known as “multi-particle entanglement” or “N-particle entanglement” (where N is greater than or equal to three). The SPDC process is known in the art and, therefore, will not be discussed in detail herein.

Although SPDC and related processes may potentially be used to generate more than two entangled photons from a single initial photon, for the sake of simplicity the following discussion is primarily directed toward a preferred embodiment in which the entanglement process generates exactly two entangled photons. A discussion of the photon source and SPDC process is provided in U.S. Pat. No. 6,252,665 B1 issuing from application Ser. No. 09/393,451, to Williams et al. on Jun. 26, 2001, the disclosure of which is hereby incorporated herein by reference.

In a preferred embodiment, photons which are not down-converted by the SPDC process are directed toward beam dump 105 where their energy is preferably dissipated without disturbing the rest of transmitter 100. After down conversion, the entangled photons preferably pass through spectral band-pass filter 104. Spectral band-pass filter 104 preferably is a standard dielectric band-pass filter having thin film layers, which filter is known in the art.

Preferably, the center frequency of band-pass filter 104 is set substantially equal to the center of a Gaussian distribution of entangled photon frequencies. According to established principles of physics, the frequencies of conjugate entangled photons sum to the frequency of the initial photon from which the entangled photons were generated. This leads to the frequencies of the entangled photons being anti-correlated about this original frequency. Thus, where the initial photon frequency is denoted by ωₚ, the center of the preferably Gaussian frequency of the entangled photons is preferably ωₚ/2. Thus, the entangled photon pairs include photons having frequencies of ωₚ/2+ω, and ωₚ/2−ω, one special case of which is the situation where ω=0 and the entangled photon pair includes photons having equal frequencies of ωₚ/2.

In a preferred embodiment, after being generated at SPDC source 103, conjugate photons of each entangled photon pair proceed along separate conjugate photon trajectories 111-a and 111-b within transmitter 100. After both conjugate photon trajectories 111-a and 111-b pass through spectral band-pass filter 104, the operation of which is discussed above, conjugate photon trajectories 111-a and 111-b preferably pass through lenses 106-a and 106-b, respectively. Lenses 106-a and 106-b preferably operate to focus light emerging from SPDC source 103 into a fiber optic cable which process is known in the art. As is known in the art, mirrors or other optical focusing apparatus may be used in place of lenses 106-a and 106-b. While conjugate photon trajectories 111-a and 111-b preferably employ fiber optic cable, any optical physical link may be employed, including free space.

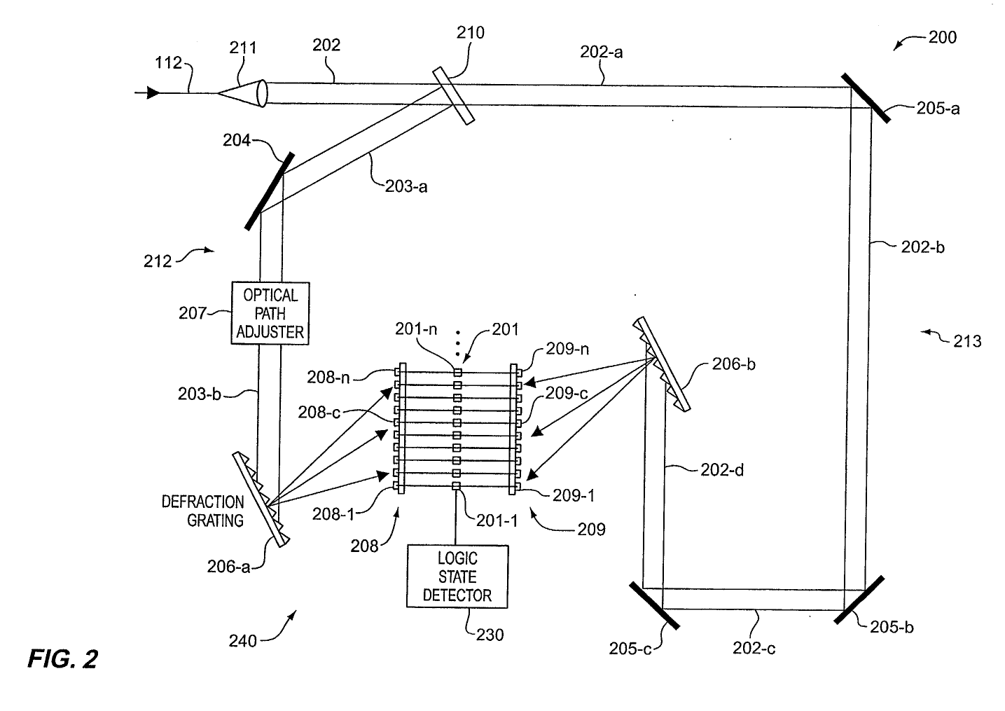

In a preferred embodiment, along conjugate photon trajectory 111-b, optical path adjuster 108 is implemented to equalize the optical path length of conjugate photon trajectories 111-a and 111-b, when modulator 107 is turned off, for conjugate photons both having frequencies of ωₚ/2. Otherwise stated, the objective of properly adjusting optical path delay adjuster 108 is to ensure that conjugate photons having substantially identical frequencies of ωₚ/2, which are simultaneously generated at SPDC source 103, arrive simultaneously at beam splitter 210 (FIG. 2). Such simultaneous arrival at beam splitter 210 results in quantum interference for such equal-frequency entangled photon pairs, leading in turn to a lack of coincidence for the center coincidence detector element of coincidence circuit array 201. Thus, proper adjustment of optical path adjuster 108 effectively calibrates the inventive communication system to ensure that a transmission from transmitter 100 incorporating the logic zero condition at transmitter 100 corresponding to modulator 107 being turned off appropriately leads to the logic zero condition at receiver 200 corresponding to a coincidence decline at the center coincidence detector element of coincidence circuit array 201. Such calibration is preferably performed during a set mode prior to operation of the inventive system for communication purposes.

It will be appreciated that, once optical path delay adjuster 108 is adjusted to ensure simultaneous arrival of conjugate photons each having a frequency of ωₚ/2, pairs of entangled photons having other frequency combinations will generally not experience simultaneous arrival at beam splitter 210 even though simultaneously generated at SPDC source 103.

Optical path adjuster 108 may be adjustable intermittently to ensure that the desired optical path length equality is in effect between trajectories 111-a and 111-b (in the condition where modulator 107 is turned off) but generally has a static setting during operation of transmitter 100.

Preferably, a modulator 107 is disposed along the trajectory of one of a pair or group of entangled photons to enable the incorporation of a bit value within the transmission of a pair or group of entangled photons. In the embodiment of FIG. 1, modulator 107 is preferably disposed along conjugate photon trajectory 111-a, which trajectory preferably consists of a fiber optic cable between lens 106-a and coupler 109. A source of classical information 120 is preferably connected to modulator 107.

In a preferred embodiment, modulator 107 incorporates either a logical high or logical low bit value into a transmission of entangled photons from transmitter 100. While the discussion presented herein is primarily directed toward the incorporation of one of two bit values, it will be appreciated that a greater number of logical states could be selected from for incorporation into an entangled photon transmission by selecting a greater number of values for optical path length modulation and associating each of these modulation values with a different logical state. A number of logical states greater than two could also be incorporated into an entangled photon transmission by controlling characteristics of the entangled photons other than the optical path length of their trajectories, such as their polarization, their frequency, or some other parameter.

To conduct digital communication employing entangled photons, it is desirable to modify a characteristic of a pair or group of entangled photons at a transmitter, such as transmitter 100, in a manner detectable to a receiver, such as receiver 200 (FIG. 2). In this manner, the setting of a selected characteristic of the entangled photons may be associated with a particular bit value or logical state within both transmitter 100 and receiver 200.

Preferably, an association between each bit value and its associated degree of modulation is established within both a transmitter and a receiver within a communication system. In one preferred embodiment of the present invention, a bit value of “0” or a “logic low” is associated with an absence of optical path length modulation, and a bit value of “1” or a “logic high” is associated with a finite increase in the optical path length along path 111-a.

Generally, two variables affect the optical path length traversed by a photon: the physical length traveled by the photon, and the index of refraction of the medium at each stage of the photon's travel. Either one or both of these variables may be employed to modify the optical path length of conjugate photon trajectory 111-a employing modulator 107. Specifically, to affect the optical distance traveled by a photon, a photon trajectory affected by modulator 107 may be readjusted using reflection and redirection to cause a photon propagated along trajectory 111-a to travel a specified physical distance. Preferably, a controller or other intelligent device would be enabled to automatically implement changes to such physical distance to cause specified bit values to be reflected in the optical path length traveled by the photon on trajectory 111-a.

The index of refraction of a portion of path 111-a, preferably that portion occupied by modulator 107, may also be modified to affect the optical path length along path 111-a, to thereby cause specified bit values to be incorporated in the optical path length traversed by the photon on trajectory 111-a. Control of the index of refraction of an optical trajectory through, or in proximity to, a modulator is generally accomplished by an electro-optical transducer which utilizes a material in which the index of refraction is a strong function of the voltage applied to the material, or, equivalently, a strong function of the applied electric field within said material. As the voltage across the material is changed, the index of refraction, and thus the optical path length, changes. Other systems operate by controlling the intensity of an electromagnetic field incident upon a fiber optic cable or other communication link. Those of skill in the art will be able to select commercially available modulators adaptable for use with the present invention.

Moreover, a combination of geometric path length modification and refraction index modification may be implemented to establish a desired path length, and all such variations are intended to be included within the scope of the present invention.

In an alternative embodiment, one or more modulators could be deployed on either or both of conjugate photon trajectories 111-a and 111-b. Moreover, each modulator may be directed to modify either linear travel distance, an index of refraction of a finite portion of a conjugate photon trajectory, or a combination of the two.

In a preferred embodiment, separate conjugate photon trajectories 111-a and 111-b are joined at coupler 109, and the photons traveling thereon are transmitted over communication link 112 to receiver 200 (FIG. 2). Communication link 112 may be a fiber optic cable, free space, or any other suitable optical communication link.

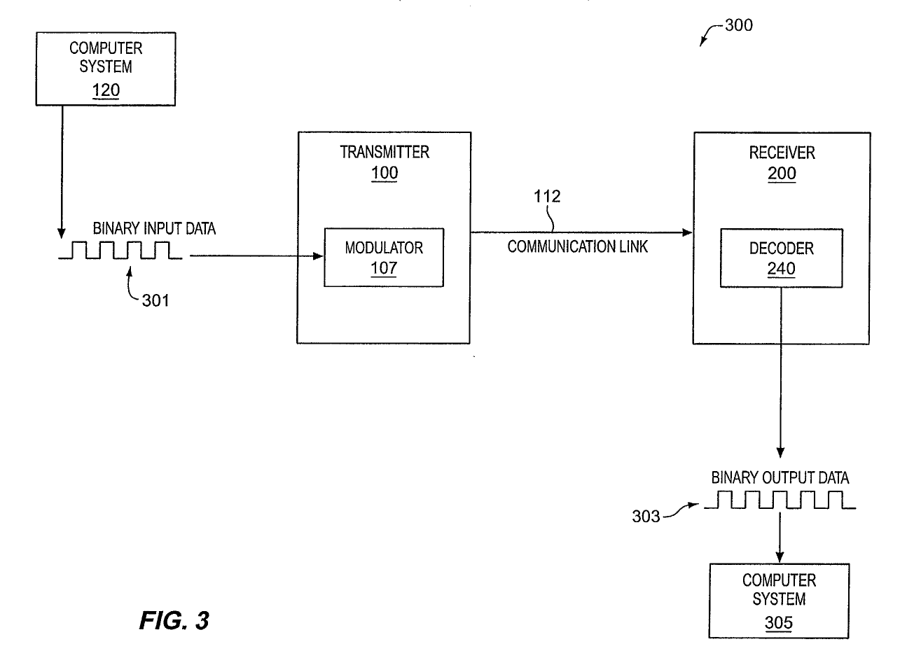

FIG. 2 is a block diagram of receiver 200 for receiving entangled photons according to a preferred embodiment of the present invention. Preferably, receiver 200 receives a pair of entangled photons over communication link 112 and extracts a bit value or logical state from the transmitted photons for conversion into binary output data 303 (FIG. 3).

In a preferred embodiment, photons arriving at receiver 200 are directed through a collimating lens 211 which focuses the photons into a collimated beam 202, which beam is shown separated into beam portions 202-a, 202-b, and 202-c. After traveling a certain distance along beam portion 202-a, the received photons encounter beam splitter 210. Beam splitter 210 is preferably a 50/50 beam splitter, the operation of which is well known in the art. The designation of “50/50” for beam splitter 210 indicates that, in general, fifty percent of photons incident upon beam splitter 210 are reflected, and fifty percent are transmitted. As is discussed in greater detail elsewhere herein, an exception to this beam splitter operational parameter arises where photons arrive at beam splitter 210 simultaneously. In this special case, the simultaneously arriving photons are either both reflected or both transmitted, but are not separated and sent along the two alternate paths provided within receiver 200.

In a preferred embodiment, the light carried along reflection path 212 and transmission path 213 are in the form of collimated beams directed through free space. Alternatively, other optical conducting means could be employed including, but not limited to, optical fiber.

In a preferred embodiment, photons reflected at beam splitter 210 proceed along beam portion 203-a, are redirected at mirror 204, then proceed along beam portion 203-b, through optical path adjuster 207 and toward diffraction grating 206-a.

In a similar manner, photons transmitted through beam splitter 210 preferably proceed along beam portion 202-a, are redirected at reflector 205-a, proceed along beam portion 202-b, are redirected at reflector 205-b, proceed along beam portion 202-c, are redirected at reflector 205-c, and proceed along beam portion 202-d toward diffraction grating 206-b. Mirrors 204, 205-a, 205-b, and 205-c are preferably simple flat reflectors which do not introduce any power to the light reflected therefrom and do not induce any bending of the light rays. Preferably, these reflectors are selected so as to achieve substantially complete reflection of the light within the wavelength range generally observed within receiver 200.

Preferably, optical path adjuster 207 is adjusted so as to make the receiver 100 photon reflection path along beam 203 and the photon transmission path along beam 202 substantially equal. Optical path adjuster 207 may be implemented by controlling (either extending or shortening) the physical length of reflective path 212 and/or by controlling the index of refraction for a selected portion of reflective path 212.

The photons received on fiber link 112 and passed along paths 202 and 203 are directed to a decoder 240, which preferably comprises diffraction gratings 206-a and 206-b, detector arrays 208 and 209, coincidence circuit array 201, and logic state detector 230.

In a preferred embodiment, the combination of diffraction grating 206-a and detector array 208 operates as a spectrometer. Specifically, diffraction grating 206-a preferably operates to separate and redirect the reflected photons according to their frequencies. Preferably, photons with the lowest frequencies are directed toward the lower portion of detector array 208, those with the highest frequencies toward the upper end of detector array 208, and those having the center frequency of ωₚ/2 toward the center of detector array 208. Alternatively, other means for separating the incoming light into its component wavelengths may be implemented, such as, for instance, a prism, thin film dielectric filters, fiber Bragg gratings, and all such variations are intended to be included in the scope of the present invention.

In a preferred embodiment, the combination of diffraction grating 206-b and detector array 209 operates as a spectrometer as discussed above in connection with diffraction grating 206-a and detector array 208. However, diffraction grating 206-b is preferably configured to direct higher frequency photons toward the bottom portion of detector array 209, lower frequency photons toward the upper portion of detector array 209, and center frequency ωₚ/2) photons toward the center of detector array 209. In this manner, where one photon of an entangled photon pair travels along receiver reflection path 212 and its conjugate photon travels along receiver transmission path 213, the two photons are preferably directed to detector elements within detector arrays 208 and 209 which are coupled to a common coincidence detector element within coincidence circuit array 201.

Generally, for any coincidence circuit within coincidence circuit array 201, the frequencies of conjugate entangled photons received at detector elements within detector arrays 208 and 209 sum to the frequency of the initial photon from which the entangled photon pair was generated. In this manner, conjugate photons of an entangled photon pair, which are first separated at SPDC source 103, are directed toward the same coincidence circuit, via conjugate detector elements, to test for a degree of coincidence of arrival at this same coincidence circuit. Thus, in general, where a high frequency photon of an entangled photon pair is directed toward uppermost detector element 208-n of detector array 208, its conjugate, low frequency photon is directed toward uppermost detector element 209-n of detector element 209. Where the disparity in arrival time between conjugate photons of an entangled photon pair at a coincidence circuit coupled to their respective conjugate detector elements is less than a defined coincidence gate time, one coincidence count is preferably generated for that coincidence circuit. Apparatuses suitable for operation as detectors include, but are not limited to, avalanche photodiodes and photomultiplier tubes. It is believed that two-photon detectors, which are currently under development, would also be suitable as detectors. In the case of two-photon process detectors, a count is generated only upon receiving two photons at once, thereby advantageously obviating a need for a separate coincidence circuit. See Dmitry V. Strekalov et al., “Two-Photon Processes in Faint Biphoton Fields”, arXiv:quant-ph/0203129 v1 26 Mar 2002.

Preferably, the output of the coincidence circuit array is passed to a logic state detector 230, which, using the indicators discussed above and below which indicate a logic “1” or logic “0” state, resolves the presence and/or absence of photon coincidence(s) within coincidence circuit array 201 into a bit value to generate binary output data 303 (FIG. 3). Logic state detector 230 may be a general purpose computer employing software adapted to cooperate with a preferred embodiment of the present invention. Alternatively, logic state detector 230 may be dedicated hardware adapted to cooperate with the output of coincidence circuit array 201. In yet another alternative embodiment, logic state detector 230 could include a combination of special purpose hardware operating in conjunction with a general purpose computer, and all such variations are intended to be included within the scope of the present invention.

FIG. 3 is a block diagram 300 of a portion of a communication system employing the transmission of entangled photons according to a preferred embodiment of the present invention. Some of the components depicted in FIG. 3 were previously discussed in connection with FIGS. 1 and 2. Accordingly, the detailed operation of these components will not be repeated in this section. FIG. 3 is intended to illustrate one possible way of employing the apparatus of FIGS. 1 and 2 for digital communication purposes.

In a preferred embodiment, computer system 120 generates binary input data 301, as is well known in the art. Binary input data 301 is then preferably transmitted to modulator 107 to enable selective control of the modulation of the optical path length of a photon trajectory controlled by modulator 107. While the device providing binary input data 301 is depicted as a computer system 120, it will be appreciated that a wide range of digital and/or analog communication and/or digital data processing devices may be employed to generate binary input data 301, and all such variations are intended to be included within the scope of the present invention. Binary input data 301 may be sent directly to modulator 107, in which case modulator 107 preferably includes a mechanism for converting such data into modulation control. Alternatively, an intermediary device, disposed in between computer system 120 and modulator 107, could be employed to convert binary input data 301 into a form suitable for direct communication to modulator 107.

Preferably, each possible bit value is associated with a unique path length adjustment at modulator 107. In one embodiment, a bit value of “0” would cause modulator 107 to leave an optical path unmodified, and a bit value of “1” would cause modulator 107 to extend the optical path length under its control by a finite predetermined value. However, the present invention is not limited to this correlation of bit values with optical path length modification. Alternatively, a bit value of “1” could be correlated with an unmodified optical path, while a bit value of “0” could be correlated with a selected finite optical path extension. In another alternative embodiment, “0” bit values and “1” bit values could be correlated with different finite additions and/or subtractions from the optical path length by controlling modulator 107, and all such variations are intended to be included within the scope of the present invention.

Generally, one bit value is transmitted by transmitter 100 by establishing a path length modification value corresponding to this bit value for a defined time period. Accordingly, a sequence of bit values is preferably transmitted by establishing a succession of path length modification values at modulator 107, with each such modification value being active at modulator 107 for a substantially constant pre-determined time period.

In a preferred embodiment, photons are then transmitted over communication link 112 to receiver 200. The apparatus forming communication link 112, receiver 200, and decoder 240 were discussed in detail in connection with FIG. 2. In a preferred embodiment, the coincidence circuit array 201 within decoder 240 generates information about the number and location of photon coincidences occurring at its component coincidence circuit detector elements 201-1 to 201-n. As discussed elsewhere herein, a bit value may be gleaned from information regarding the number and locations of such photon coincidences employing suitable processing. Such processing may be provided by logic state detector 230.

In one embodiment, a logical value of “0” may be deduced from the absence of coincidence counts at a coincidence circuit (such as the central coincidence circuit) coupled to conjugate detector elements receiving photons at identical frequencies coupled with the existence of a substantial number of coincidence counts at coincidence counters coupled to detector elements receiving photons at substantially different frequencies. In an alternative embodiment, a logical value of “1” may be gleaned from a substantial coincidence count at the above-discussed central coincidence circuit.

In a preferred embodiment, logic state detector 230 portion of decoder 240 produces binary output data 303, which preferably matches the binary input data 301 originally input to modulator 107. Once generated, binary output data 303 may be communicated to any device having a suitable digital communication interface including, but not limited to, a general purpose computer, such as computer system 305. Preferably, computer system 305 includes both conventional RAM (random access memory) as well as non-volatile data storage such as, for instance, one or more floppy drives, and/or one or more hard disk drives. Where desired, binary output data 303 may be stored in one or more of such data storage means.

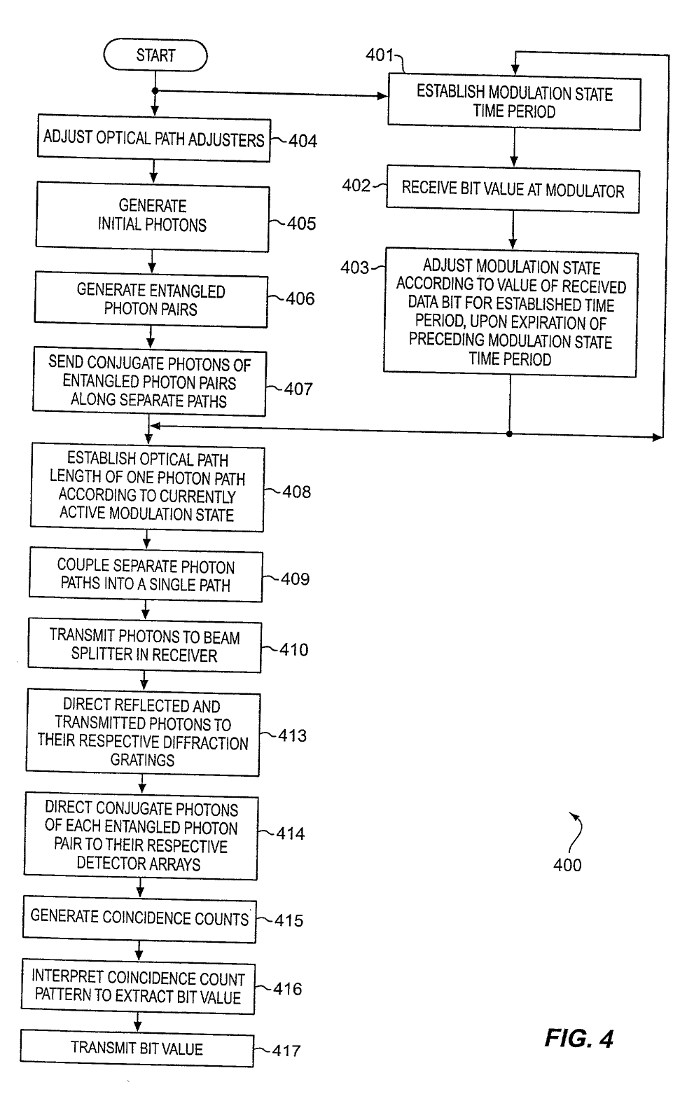

FIG. 4 is a flow diagram 400 of the operation of the inventive system according to a preferred embodiment of the present invention. In the following discussion, reference is made to components depicted in FIGS. 1-3. Blocks 401-403 refer to operations generally conducted at or in conjunction with modulator 107.

In a preferred embodiment, at block 401, a modulation state time period is established. A general purpose computer or dedicated hardware component may be employed to establish a time period during which an optical path length modification effected by modulator 107 remains in effect. It will be appreciated that the modulation state time period need not be established for each cycle. Instead, a modulation state time period could be established once and then employed for a sequence of bit value transmissions. In another preferred embodiment, rather than establishing the modulation state time period in block 401, the inventive system may allow such time period to set so as to accommodate the data transmission rate of the binary input data 301 (FIG. 3).

At block 402, modulator 107 preferably receives a bit value to be incorporated into entangled photon pairs to be transmitted by transmitter 100. At block 403, the modulation state of modulator 107 is preferably adjusted to reflect the bit most recently received at modulator 107 upon expiration of a preceding modulation state time period. Preferably, where there is no preceding modulation state time period, a current modulation state time period may begin immediately. Where there is a preceding modulation state time period, the succeeding modulation state time period, as indicated in FIG. 4, preferably begins only upon expiration of this preceding period.

In a preferred embodiment, the modulation state corresponding to a bit value of a logical “0” leaves the optical path length of path 111-a unchanged, and the modulation state corresponding to a bit value of a logical “1” extends the optical path length of path 111-a by a finite amount. However, it will be appreciated that other combinations of path length modifications based on bit values are available, and all such variations are intended to be included within the scope of the present invention.

In a preferred embodiment, the modulation state generated in block 403 is available to the operation of block 408 as is discussed elsewhere herein. Preferably, the adjustment of the modulation state in block 403 establishes start and end times for the current modulation state time period. Alternatively, consistent with the discussion herein in connection with block 401, the start and end times for the modulation state time period may be allowed to conform to the data transmission rate of the binary input data 301 (FIG. 3).

Execution then preferably resumes at block 401 where the time period of the next modulation state is established. It may be seen that the operation of blocks 401-403 preferably allows an infinite sequence of bit values to be received at modulator 107 and for the modulation states of modulator 107 to be appropriately established for each of these bits for a suitably selected time period.

At block 404, the optical path lengths of alternate light paths, for a selected set of entangled photon frequencies, are preferably equalized by adjusting the value of optical path adjuster 108. The pertinent trajectory over which optical path length is preferably equalized is that between SPDC source 103 and beam splitter 210. In a preferred embodiment, the optical path lengths of the alternate paths between SPDC source 103 and beam splitter 210 are equalized for entangled photon pairs in which both photons of such pairs have equal frequencies equaling ωₚ/2. Preferably, a similar procedure is conducted in order to adjust the value of optical path adjuster 207 within receiver 200.

This arrangement preferably establishes a system in which the location of a coincidence decline among the circuits within coincidence circuit array 201 unambiguously identifies, at receiver 200, the bit value incorporated into an ensemble of photons transmitted while a particular modulation setting was active at modulator 107.

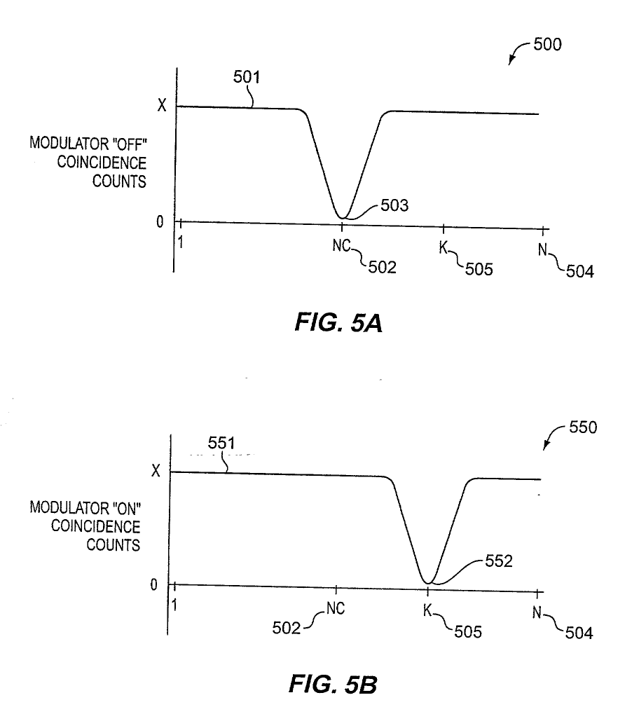

Specifically, when the optical path length of the alternate photon paths between SPDC source 103 and beam splitter 210 is equalized for pairs of photons, in which pairs each photon has a frequency of ωₚ2, the photons of such pairs will either be both reflected or both transmitted at beam splitter 210, thereby leading to a coincidence decline (which may be a coincidence null) for such photon pairs within coincidence circuit array 201. This result arises from the effects of quantum interference, which effects are known in the art. Referring to graph 500 of FIG. 5A, it may be seen that plot line 501 experiences a decline at center coincidence detector element NC 502. Abscissa value NC 502 in FIG. 5A preferably corresponds to the coincidence circuit which is coupled to detector elements 802-nc and 902-nc (FIG. 2).

Generally, photon pairs having other combinations of conjugate photon frequencies will experience coincidence within coincidence circuit array 201. This phenomenon may also be observed in FIG. 5A which depicts most of the coincidence detector elements experiencing coincidence counts equal to “X.”Accordingly, after an ensemble of photons has been received at receiver 200, the existence of a coincidence decline at coincidence circuit NC 502 (the center coincidence circuit) associated with photons having frequencies of ωₚ/2 is preferably interpreted as corresponding to a bit value of logic “0”. The absence of coincidence declines at coincidence circuits receiving photons having other frequency combinations, demonstrated by the existence of finite coincidence counts at such coincidence circuits, preferably operates to confirm the interpretation of a logic “0” from the pertinent photon ensemble transmission.

In a preferred embodiment, when modulator 107 is turned on, corresponding to a bit value of logic “1”, center coincidence circuit (or coincidence detector element number NC 502) experiences a finite coincidence count and therefore the absence of a coincidence decline. Exemplary graph 550 in FIG. 5B shows coincidence detector element NC 502 having a coincidence count equal to “X”.

This absence of a coincidence decline at the center coincidence circuit is preferably interpreted as corresponding to a logical “1” for the pertinent photon ensemble transmission. Preferably, the detection of a coincidence decline at a coincidence detector element other than the center coincidence circuit preferably operates to further confirm the association of a logical “1” with the pertinent photon ensemble transmission. By way of example, it may be seen in FIG. 5B that a decline 552 in coincidence curve 551 occurs at coincidence detector element K 505 and not at detector element NC 502.

It will be appreciated that either the absence of a coincidence decline at the center coincidence circuit or the presence of a coincidence decline at a circuit other than the center coincidence circuit may each be sufficient to associate the pertinent photon ensemble transmission with a logical “1” bit value.

In a preferred embodiment, the path length equalization of block 404 is accomplished by appropriate adjustment of optical path adjuster 108. Such adjustment may be accomplished mechanically, electronically, and/or employing a general purpose computer with a suitable interface. This adjustment may be performed with operator intervention or automatically. In a preferred embodiment, once optical path delay adjuster 108 is properly set, this setting is preferably valid for a large number of photon ensemble transmissions. The setting may be examined from time to time to ensure the correctness of its adjustment.

In a preferred embodiment, optical path adjuster 207 within receiver 200 is also adjusted. Generally, optical path adjuster 207 is adjusted to make the reflection and transmission paths between beam splitter 210 and coincidence circuit array 201 at least substantially equal, although exact path length equality is not required. Preferably, effective adjustment of optical path adjuster 207 operates to maximize the number of coincidences occurring at various coincidence circuits within coincidence circuit array 201 for a given coincidence gate time. The above discussion of the methods available for adjusting optical path adjuster 108 are also available for the adjustment of optical path adjuster 207.

At block 405, initial photons are preferably generated employing photon source 101. Preferably, these generated photons all have frequency ωₚ, which value was discussed previously herein. At block 406, entangled photon pairs are generated from a selection of the initial photons generated in block 406. According to the principles of physics, which are known in the art, a property of such entangled photon pairs is that the sum of the frequencies of an entangled photon pair is equal to the frequency of the initial photon from which the entangled photon pair was generated.

At block 407, conjugate photons of entangled photon pairs are sent along separate paths. This act preferably enables selective modulation of the optical path length of a trajectory of one conjugate photon of each entangled photon pair.

At block 408, the optical path length of photons traveling along the path affected by modulator 107 is established. During the time period established in block 401, photons traveling along the light path affected by modulator 107 will preferably all undergo a path length modification (which may be any one of an unchanged path length, a finite optical path length increase, or a finite optical path length decrease) consistent with a currently active bit value being implemented by modulator 107.

At block 409, the photons traveling along separate paths are preferably reunited onto a single path. At block 410, photons are preferably transmitted to receiver 200.

At block 413, the photons reflected at beam splitter 210, and those transmitted through beam splitter 210, are preferably directed along their respective paths toward their respective diffraction gratings. At block 414, conjugate photons of entangled photon pairs are preferably directed to their respective detector arrays. Thereafter, at block 415, coincidence counts at the various coincidence detectors are preferably generated.

At block 416, the coincidence bit pattern is processed to glean therefrom a bit value according to templates of expected coincidence patterns associated with logical “0” and logical “1” photon ensemble bit value transmissions. Thereafter, at block 417, the bit value extracted at block 416 is preferably transmitted to a destination device employing a suitable interface and communication link.

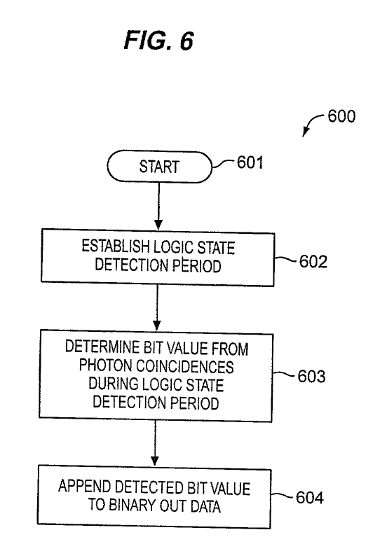

FIG. 6 is a flow diagram 600 of output data generation at a receiver 200 according to a preferred embodiment of the present invention. The inventive method preferably starts at block 601. At step 602, the logic state detection period is preferably established. Preferably, the logic state detection period substantially corresponds to the modulation state time period established in step 401 (FIG. 4). While the logic state detection period is preferably established and/or verified in step 401 for each cycle of the flow shown in FIG. 6, in an alternative embodiment, this period could be established just once in connection with a large number of such cycles and changed only in response to a specific instruction. This period-changing instruction could be provided either manually or through machine input.

In an alternative embodiment, data packets could be transmitted from transmitter 100 to receiver 200, which data packets could include a preamble having a known sequence of bits which enables receiver 200 to synchronize its bit evaluation operation with the transmission rate of transmitter 100. In this manner, the logic state detection period of receiver 200 is preferably caused to correspond to the modulation state time period of transmitter 100.

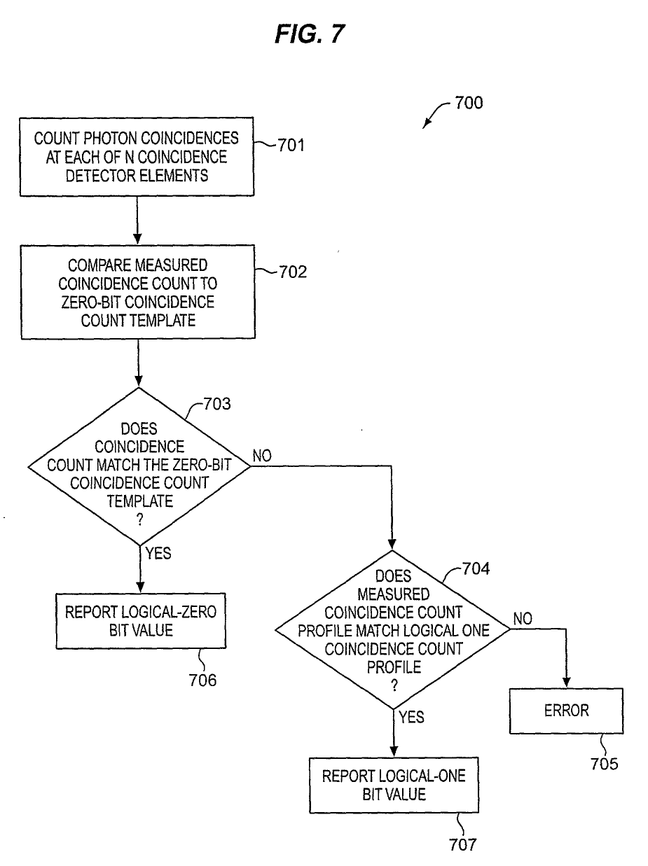

In a preferred embodiment, a bit value is determined from a count of photon coincidences occurring within a current logic state detection period in block 603. The details of this operation are discussed in greater detail in FIG. 7. In block 602, the bit value or logic state determined in block 603 is preferably appended to binary output data generated by receiver 200.

FIG. 7 is a flow diagram 700 of bit value determination from coincidence count profiles according to a preferred embodiment of the present invention. The operations described within flow diagram 700 generally correspond to the operation of block 603 in FIG. 6.

For the sake of brevity, in this discussion of FIG. 7, the pertinent coincidence detector elements are numbered 1 (201-1 in FIG. 2) through N (201-n in FIG. 2), with the center element being numbered NC. The coincidence detector element at which the coincidence decline center is located for the condition where modulator 107 is on is denoted as K.

In a preferred embodiment, in block 701, the inventive method counts photon coincidences occurring at each of N coincidence detector elements, 201-1 through 201-n, within coincidence circuit array 201. Preferably, the counting operation of block 701 provides a coincidence count profile such as those shown in FIGS. 5A and 5B.

In a preferred embodiment, in block 702, the coincidence count profile generated in block 701 is compared to a “0” bit value count profile such as that shown in FIG. 5A. Generally, with modulator 107 turned off, a coincidence count profile having a coincidence decline centered at or near coincidence detector element NC is expected. Acknowledging that some randomness may exist when counting coincidences from an ensemble of photons, the trajectories of which may be subject to various forms of interference, an acceptable range of coincidence decline locations may be established so as to properly identify coincidence counts which result from a “modulator off” condition. Likewise, acceptable ranges of coincidence decline depth and coincidence decline width could be established so as to allow coincidence declines, which are close to the ideal coincidence decline for a given data value but which do not exactly match such ideal coincidence decline, to be counted as valid data values. This reasoning applies equally to the coincidence declines associated with both logic zero and logic one data values.

Thus, while a “0” bit value coincidence count profile is expected to produce a profile having a coincidence decline at NC, coincidence count profiles having declines within a reasonable range of the NC detector element are preferably interpreted as corresponding to a “0” bit value (or “modulator off”) condition. A similar range of coincidence decline locations about coincidence detector element K (see FIG. 5B) may be established to establish a range of coincidence count profiles interpreted as corresponding to a logic “1” bit value (modulator on) condition. The establishment of such “ranges” about the expected locations of coincidence decline locations for the expected “0” and “1” bit value conditions need not lead to ambiguity in the logical bit value determination as long as the “0” bit value and “1” bit value ranges do not overlap.

In a preferred embodiment, in block 703, if the comparison of block 702 indicates a “0” bit value, execution branches to block 706 which reports a “0” bit value for the pertinent logic state detection period. If the comparison in block 702 does not indicate a “0” bit value, execution branches from block 703 to block 704 at which block the coincidence count profile for the current logic state detection period is compared to the profile of a logic “1” (modulator on) condition, as represented in FIG. 5B. If a logic “1” condition is not indicated, an error is indicated in block 705. If a logic “1” condition is indicated, a logic “1” bit value is preferably reported for the pertinent logic state detection period in block 707.

For the comparison in block 704, a coincidence decline is expected at coincidence detector element “K” as shown in FIG. 5B. Herein, K represents a coincidence detector element at which a coincidence decline is expected. The actual detector element number corresponding to K among the N detector elements and the precise geometric location of detector element K within coincidence circuit array 201 (FIG. 2) will depend upon various characteristics of the apparatus of FIGS. 1 and 2 including, but not limited to, the optical path length extension introduced by the activation of modulator 107, the optical path length contributions of other segments of the photon trajectories within transmitter 100 and receiver 200, and the physical arrangement of the diffraction gratings 206-a and 206-b, detector arrays 208 and 209 and coincidence circuit array 201.

As was discussed in connection with the determination of a logic “0” condition based on a coincidence decline location at or near coincidence detector element NC (FIG. 5A), a range of coincidence decline locations within reasonable proximity to coincidence detector element K may be established as corresponding to a logic “1” (modulator on) condition. In this manner, coincidence count profiles having coincidence declines in substantial proximity to, but not right at, coincidence detector element K will be considered to correspond to a logic “1” bit value.

Preferably, in addition to being suitable for implementation employing the apparatus described in this application, the quantum entangled photon-based communication technology disclosed herein is suitable for retrofitting existing communication systems. In this manner, economy may be achieved by using existing communication links, such as fiber optic cables, and selected components of existing data transmitting and data receiving equipment at various nodes within a communication network, and employing such communication links and such transmitting and receiving equipment in conjunction with the entangled photon based communication technology disclosed herein. Moreover, communication networks employing the inventive technology may include some communication segments which employ the apparatus disclosed herein and other segments which include pre-existing apparatus adapted to operate in conjunction with the inventive entangled photon-based communication technology.

There has been described an optical communication system that transmits classical information using entangled photons, and having numerous other novel features discussed herein. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiment described, without departing from the inventive concepts. For example, the system can be used in the context of a data storage system. Its use in such a system permits very rapid storage of digital data, while maintaining high accuracy, since it is relatively independent of dispersion. It is also evident that the device elements and acts recited may, in some instances, be located and performed in a different order; or equivalent structures may be substituted for the various structures described; or a variety of additional elements may be added. Consequently, the invention is to be construed as embracing each and every novel feature and novel combination of features present in and/or possessed by the system, devices, and methods described.

I claim:

1. A communication method comprising:
incorporating information into a pair of entangled photons;
transmitting said entangled photons;
receiving said entangled photons; and
extracting said information from said received pair of entangled photons.

2. The method of claim 1 wherein said incorporating comprises modulating an optical path of one of said pair of entangled photons.

3. The method of claim 2 wherein said modulating comprises selectively controlling an index of refraction for a portion of a trajectory of said one photon.

4. The method of claim 3 wherein said selectively controlling said index of refraction comprises adjusting the electromagnetic field in said portion of a trajectory.

5. The method of claim 2 wherein said modulating comprises selectively controlling a physical length of a trajectory of said one photon.

6. The method of claim 1 wherein said transmitting comprises transmitting over a fiber optic link.

7. The method of claim 1 wherein said receiving comprises directing one of said entangled photons along a first path and directing the other of said entangled photons along a second path.

8. The method of claim 7 wherein said receiving further comprises delaying said one of said entangled photons along said first path.

9. The method of claim 1 wherein there is a plurality of said entangled photon pairs and said extracting comprises spatially separating photons according to their frequency.

10. The method of claim 9 wherein said extracting further comprises impinging said spatially separated photons onto a photodetector array.

11. The method of claim 10 wherein:
said receiving comprises directing a first set of said entangled photons along a first path and directing a second set of said entangled photons along a second path;
said spatially separating comprises spatially separating said first set at a first location and spatially separating said second set at a second location;
said impinging comprises impinging said first set onto a first detector array and impinging said second set onto a second detector array; and
said extracting further comprises determining a pattern of coincidence of impingement of photons of said first set onto said first array with the impingement of photons of said second set onto said second array and producing a decoded signal characteristic of said coincidence.

12. The method of claim 11 wherein said incorporating comprises incorporating a digital logic state onto said entangled photons, and said extracting further comprises detecting said digital logic state in said decoded signal.

13. The method of claim 1 wherein said extracting comprises determining a coincidence pattern of said received entangled photons.

14. The method of claim 13 wherein said determining a coincidence pattern comprises identifying a detector element within an array of detector elements at which a coincidence decline occurs.

15. The method of claim 13 wherein said determining a coincidence pattern comprises determining that a coincidence decline does not occur at a predetermined detector element within an array of detector elements.

16. A method for communicating a digital logical state, the method comprising:
providing a digital logic state;
providing a pair of entangled photons;
establishing the optical path of one of said entangled photons in accordance with said digital logic state;
transmitting said entangled photons to a receiver; and
extracting said digital logic state from said received entangled photons.

17. The method of claim 16 wherein said extracting comprises determining a coincidence pattern of said received entangled photons at said receiver.

18. The method of claim 17 wherein said determining a coincidence pattern comprises identifying a detector element within an array of detector elements at which a coincidence decline occurs.

19. The method of claim 17 wherein said determining a coincidence pattern comprises determining that a coincidence decline does not occur at a predetermined detector element within an array of detector elements.

20. The method of claim 16 wherein said establishing the optical path comprises delaying said one of said entangled photons.

21. A communication system comprising:
an entangled photon transmitter comprising: a source of entangled photons; a source of information; and a modulator responsive to said source of information for incorporating said information into said entangled photons;
an entangled photon receiver including an entangled photon decoder providing an output signal characteristic of said information; and
a communication link for carrying said entangled photons from said transmitter to said receiver.

22. The communication system as in claim 21 wherein said source of entangled photons comprises: a source of initial photons; and a spontaneous parametric down converter for producing a group of entangled photons from each of said initial photons.

23. The communication system as in claim 21 wherein said modulator comprises an electro-optical transducer.

24. The communication system as in claim 23 wherein said electro-optical transducer comprises a material in which the index of refraction is dependent on voltage.

25. The communication system as in claim 21 wherein said decoder comprises a spectrometer and a coincidence circuit array.

26. The communication system as in claim 25 wherein said spectrometer comprises a diffraction grating and a photodetector array.

27. The communication system as in claim 26 wherein said decoder comprises a first path including a first said diffraction grating and a first said photodetector array, and a second path comprising a second said diffraction grating and a second said photodetector array.

28. The communication system as in claim 25 wherein said decoder further includes a logic state detector.

29. The communication system as in claim 28 wherein said logic state detector comprises a computer.

30. The communication system as in claim 21 wherein said communication link comprises an optical fiber.

31. The communication system as in claim 21 wherein said transmitter comprises an optical path adjuster.

32. The communication system as in claim 21 wherein said source of entangled photons comprises a pump laser.

33. The communication system as in claim 21 wherein said source of entangled photons comprises a polarizer.

34. The communication system as in claim 21 wherein said receiver includes two photon paths and an optical path adjuster along one of said optical paths.

35. The communication system as in claim 21 wherein said information comprises a sequence of bit values.

36. A data storage method comprising:
generating a plurality of entangled photon pairs;
incorporating one bit value into said generated plurality of photon pairs;
extracting said incorporated bit value upon concluding an entanglement condition of said entangled photon pairs; and
storing said extracted bit value.

37. The method of claim 36 wherein said incorporating comprises adjusting an optical path of one photon of each said entangled photon pair.

38. A communication system comprising:
an existing communication link;
an entangled photon transmitter, adapted to cooperate with said existing communication link, comprising: a source of entangled photons; a source of information; and a modulator responsive to said source of information for incorporating said information into said entangled photons; and
an entangled photon receiver, adapted to cooperate with said existing communication link, including an entangled photon decoder providing an output signal characteristic of said information, wherein said existing communication link is operative to carry said entangled photons from said transmitter to said receiver.

39. A method for providing communication employing existing communication equipment, the method comprising:
selecting an existing communication link;
coupling an entangled photon transmitter to said selected existing communication link;
coupling an entangled photon receiver to said selected existing communication link; and
transmitting information from said coupled entangled photon transmitter to said coupled entangled photon receiver.
